(19) United States
(12) Patent Application Publication
(10) Pub. No.: US 2019/0258260 A1
(43) Pub. Date: Aug. 22, 2019

(54) METHOD FOR GENERATING A SAFE NAVIGATION PATH FOR A VEHICLE AND A SYSTEM THEREOF

(71) Applicant: WIPRO LIMITED, BANGALORE (IN)

(72) Inventors: BALAJI SUNIL KUMAR, BENGALURU (IN); MANAS SARKAR, KOLKATA (IN)

(73) Assignee: WIPRO LIMITED

(21) Appl. No.: 15/942,454

(22) Filed: Mar. 31, 2018

(30) Foreign Application Priority Data
Feb. 16, 2018 (IN) 201841005944

(51) Int. Cl. G05D 1/02; G05D 1/00; G01C 21/34

(52) U.S. Cl. CPC G05D 1/0214; G05D 1/0088; G05D 2201/0213; G01C 21/3453; G05D 1/024

(57) ABSTRACT

The present disclosure relates to generation of a safe navigation path for a vehicle. The safe navigation path is generated by a navigation path generation system. The said system receives a reference path comprising a source location and a destination location. Further, generates segments along one of the left boundary and a right boundary, present on either side of the reference path. Further, projects at least one of a horizontal line and a vertical line from each of the segments, to meet the opposite boundary. Further, using the horizontal line and vertical line projected from each of the segments, the navigation path generation system generates a safe navigation path along the centre, between the boundaries present on either side of the reference path. Navigation of the vehicle along the safe path ensures the safety of vehicle and people in the vehicle, when the vehicle is an autonomous or semi-autonomous vehicle.

### TECHNICAL FIELD

The present disclosure relates to navigation of vehicles. Particularly, but not exclusively, the present disclosure relates to a method and a system for generating a safe navigation path for a vehicle.

### BACKGROUND

Vehicle, in particular autonomous vehicles (driverless vehicle) or semi-autonomous vehicles use data obtained from various sensors to navigate through a path. Also, various techniques are used to detect obstacles in the surroundings of the vehicle. The autonomous vehicles or semi-autonomous vehicles have a central control unit that analyse the data obtained from the sensors and helps the vehicle to traverse a path to reach a destination location from a source location. Also, the central control unit detects any obstacles and manoeuvres the obstacles by traversing the vehicle in an alternate path. The existing autonomous and semi-autonomous vehicles make use of a path determined by a dedicated path planning module. In few scenarios, the path planning module present in existing autonomous and semi-autonomous vehicles may produce a path that may be generated close to dividers or walls along a road or obstacles, even when a path could be generated along the centre of the road. Further, when a path is generated close to obstacle, the existing autonomous and semi-autonomous vehicles may experience difficulty in manoeuvring obstacles as there may not be enough space. Also, when a path in which the vehicle is traveling has a steep curve, the vehicle may not be able to traverse the curve easily when a path is not generated along the centre of the steep curve. Thus, existing autonomous vehicles does not provide an efficient solution to address the above-mentioned problems.

The information disclosed in this background of the disclosure section is only for enhancement of understanding of the general background of the invention and should not be taken as an acknowledgement or any form of suggestion that this information forms the prior art already known to a person skilled in the art.

### SUMMARY

In an embodiment, the present disclosure relates to a method for generating a safe navigation path for a vehicle. The method comprises receiving by a navigation path generation system, a reference path between a source and a destination. The reference path is confined between a left boundary and a right boundary. The method further comprises projecting a line perpendicular to an orientation of the vehicle present at the source, to at least one of the left boundary and the right boundary. An end point of the line projected towards the left boundary lies on the left boundary and the end point of the line projected towards the right boundary lies on the right boundary. The method further comprises generating a plurality of segments along at least one of the left boundary and the right boundary, starting from the end point of the line. Further, the method comprises determining an angle between each of the plurality of segments with at least one of a horizontal reference line and a vertical reference line. Thereafter, the method comprises projecting at least one of a horizontal line and a vertical line from a predefined point of each of the plurality of segments to an opposite boundary, based on the angle between each of the plurality of segments with at least one of a horizontal reference line and a vertical reference line. Further, the method comprises determining a centre point of the horizontal line and vertical line projected from each of the plurality of segments. Lastly, the method comprises generating a safe navigation path for the vehicle based on the centre point of the horizontal line and vertical line projected from each of the plurality of segments.

In an embodiment, the present disclosure relates to a navigation path generation system for generating a safe navigation path for a vehicle. The navigation path generation system comprises an Electronic Control Unit (ECU). The ECU is configured to receive a reference path between a source and a destination. The reference path is confined between a left boundary and a right boundary. The ECU is further configured to project a line perpendicular to an orientation of the vehicle present at the source, to at least one of the left boundary and the right boundary. An end point of the line projected towards the left boundary lies on the left boundary and the end point of the line projected towards the right boundary lies on the right boundary. The ECU is further configured to generate a plurality of segments along at least one of the left boundary and the right boundary, starting from the end point of the line. The ECU is further configured to determine an angle between each of the plurality of segments with at least one of a horizontal reference line and a vertical reference line. Thereafter, projects at least one of a horizontal line and a vertical line from a predefined point of each of the plurality of segments to an opposite road boundary, based on the angle between each of the plurality of segments with at least one of a horizontal reference line and a vertical reference line. Further the ECU is configured to determine a centre point of the horizontal line and vertical line projected from each of the plurality of segments and generate a safe navigation path for the vehicle based on the centre point of the horizontal line and vertical line projected from each of the plurality of segments.

In an embodiment, the present disclosure relates to a non-transitory computer readable medium including instruction stored thereon that when processed by at least one processor cause a navigation path generation system to receive a reference path between a source and a destination. The reference path is confined between a left boundary and a right boundary. The instruction may cause the processor to project a line perpendicular to an orientation of the vehicle present at the source, to at least one of the left boundary and the right boundary. An end point of the line projected towards the left boundary lies on the left boundary and the end point of the line projected towards the right boundary lies on the right boundary. The instruction may cause the processor to generate a plurality of segments along at least one of the left boundary and the right boundary, starting from the end point of the line. The instruction may cause the processor to determine an angle between each of the plurality of segments with at least one of a horizontal reference line and a vertical reference line, project at least one of a horizontal line and a vertical line from a predefined point of each of the plurality of segments to an opposite road boundary, based on the angle between each of the plurality of segments with at least one of a horizontal reference line and a vertical reference line, determine a centre point of the horizontal line and vertical line projected from each of the plurality of segments; and generate a safe navigation path for the vehicle based on the centre point of the horizontal line and vertical line projected from each of the plurality of segments.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The novel features and characteristic of the disclosure are set forth in the appended claims. The disclosure itself, however, as well as a preferred mode of use, further objectives and advantages thereof, will best be understood by reference to the following detailed description of an illustrative embodiment when read in conjunction with the accompanying figures. One or more embodiments are now described, by way of example only, with reference to the accompanying figures wherein like reference numerals represent like elements and in which:

FIG. 1 illustrates an exemplary block diagram of a navigation path generation system for generating a safe navigation path for a vehicle, in accordance with some embodiments of the present disclosure;

FIG. 2 illustrates a block diagram of internal architecture of an Electronic Control Unit (ECU) configured to generate a safe navigation path for a vehicle, in accordance with some embodiments of the present disclosure;

FIG. 3 shows an exemplary flow chart illustrating method steps for generating a safe navigation path for a vehicle, in accordance with some embodiments of the present disclosure;

FIG. 4, FIG. 5, FIG. 6, and FIG. 7 illustrates an example and the steps involved in generating a safe navigation path for a vehicle, in accordance with some embodiments of the present disclosure.

FIG. 8 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

Embodiments of the present disclosure relate to generation of a safe navigation path for a vehicle. The safe navigation path is generated by a navigation path generation system. The navigation path generation system receives a reference path comprising a source location to a destination location. The reference path is confined between a left boundary and a right boundary. Further, the navigation path generation system generates segments of pre-determined length along one of the left boundary and a right boundary, present on either side of the reference path. Further, the navigation path generation system determines an angle between each of the segments and at least one of a horizontal reference line and a vertical reference line. Further, the navigation path generation system projects at least one of a horizontal line and a vertical line from a predefined point on each of the segments based on the determined angle, to meet the opposite boundary. Using a centre point of the horizontal line and vertical line projected from each of the segments, the navigation path generation system generates a safe navigation path, between the boundaries present on either side of the reference path.

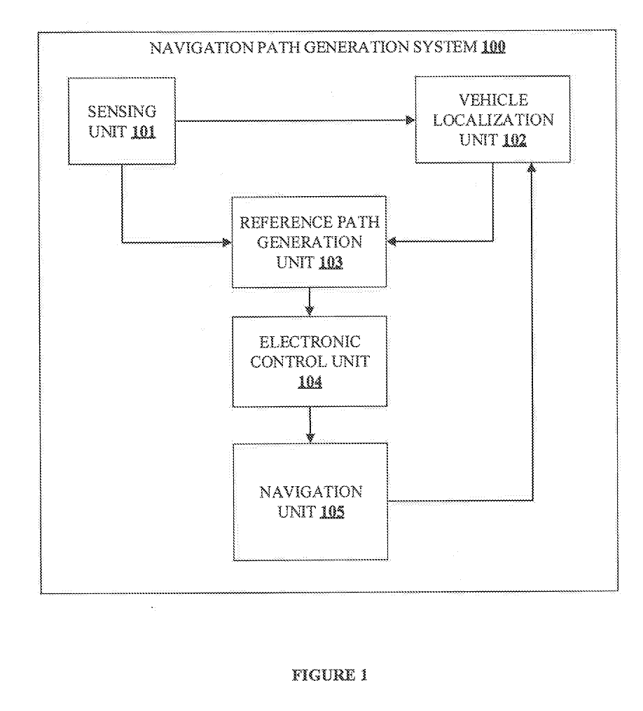

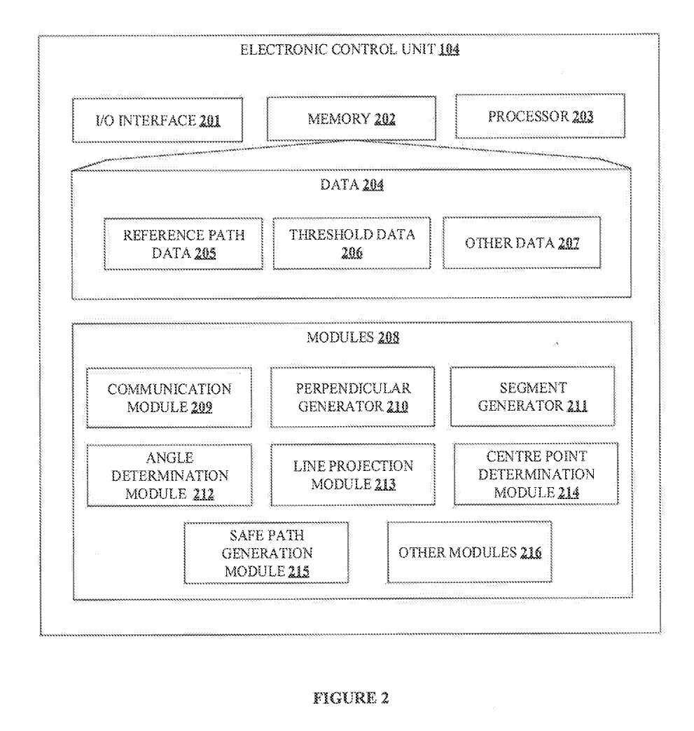

FIG. 1 illustrates an exemplary block diagram of a navigation path generation system 100 for generating a safe navigation path for a vehicle, in accordance with some embodiments of the present disclosure. The navigation path generation system 100 comprises a sensing unit 101, a vehicle localization unit 102, a reference path generation unit 103, an electronic control unit 104 and a navigation unit 105. In an embodiment, the navigation unit 105 may be configured as a separate unit. In an embodiment, the sensing unit 101 may comprise variety of sensors used for sensing the environment and surroundings of the vehicle. Various techniques, employing the variety of sensors may include, but are not limited to, camera imaging, Radio Detection and Ranging (RADAR), Light Detection and Ranging (LIDAR), odometry and computer vision. The various techniques employed by the sensing unit 101 provides information about the surroundings and environment of the vehicle. The information may include, but not limited to, location of vehicle, location of obstacles around the vehicle, distance of an obstacle from the vehicle and any other environmental parameter. A map generator unit (not shown) may receive data from the sensing unit 101 to generate a static map. In an embodiment, the static map may be generated using LIDAR data. The static map may be generated using existing techniques or any techniques that may be employed to generate the static map. The vehicle localization unit 102 may obtain information from the sensing unit 101 and may also receive information on speed of the vehicle from the navigation unit 105 and determines an initial position of the vehicle. Further, the vehicle localization unit 102 may determine a path for the vehicle based on the initial position of the vehicle and the static map. The path may be used by the vehicle for navigation. Further, the vehicle localization unit 102 may also determine the orientation of the vehicle with respect to the path. In an instance, the static map may be generated using LIDAR data, obtained from the sensing unit 101. The reference path generation unit 103 receives the static map from the map generator unit and receives data from the vehicle localization unit 102. Further, based on the static map, the reference path generation unit 103 may generate a reference path between a source location and a destination location based on parameters obtained from the sensing unit 101 and the vehicle localization unit 102. The parameters may include, but are not limited to, speed of the vehicle, initial position of the vehicle, orientation of the vehicle, Field of View (FOV) of the sensors employed in the sensing unit 101 and the like. In an embodiment, the destination location may be obtained from a user.

In an embodiment, let us consider a road or a way is joining the source location and the destination location. The reference path may be a random navigation path along the road joining the source location and the destination location. The reference path may be confined between a boundary on the left side of the road and a boundary on the right side of the road. The boundary on the left side may be referred to as a left boundary and the left boundary may be a path along a left edge of the road. The boundary on the right side may be referred to as a right boundary and the right boundary may be a path along a right edge of the road.

In an embodiment, the reference path along at least one of the left boundary and right boundary is received by the ECU 104. The ECU 104 projects a line perpendicular to the orientation of the vehicle to at least one of the left boundary or the right boundary. Further the ECU 104 generates the plurality of segments along at least one of the left boundary and the right boundary starting from an end point of the perpendicular line. Further, the ECU 104 determines an angle between each of the plurality of segments and at least one of a horizontal reference line and a vertical reference line. Further, the ECU 104 projects at least one of a horizontal line and a vertical line from a predefined point on each of the plurality of segments based on the determined angle, to meet an opposite boundary. Furthermore, the ECU 104 determines a centre point of each of the horizontal line and vertical line projected from each of the plurality of segments. Using the centre point of the horizontal line and vertical line projected from each of the segments, the ECU 104 generates a safe navigation path for the vehicle along the centre of the road. The safe navigation path may be a path along the centre of the road joining the source location and the destination location and may be used by the vehicle to navigate from the source location to the destination location safely. In an embodiment, the safe navigation path may be a straight path, a curved path, a combination of straight and curved path or any other kind of path. However, the safe path may always be a path along the centre of the road. The navigation unit 105 receives the safe navigation path and enables the vehicle to navigate from the source location to the destination location along the safe path.

In an embodiment, the one or more sensors employed by the sensing unit 101 may include, but are not limited to, a LIDAR sensor, an ultrasound sensor, a camera, a proximity sensor and the like.

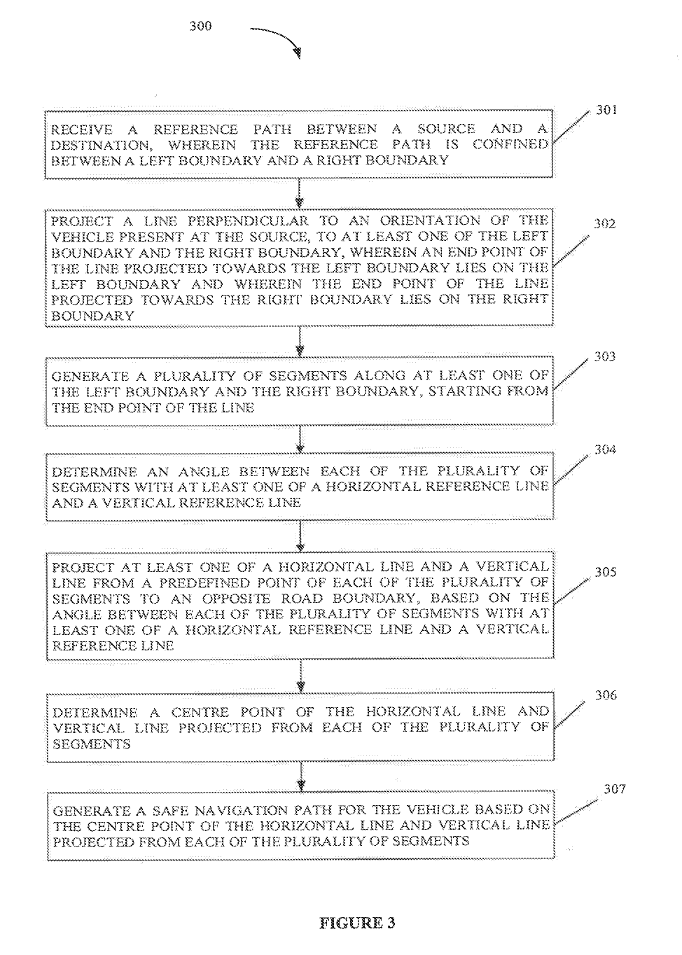

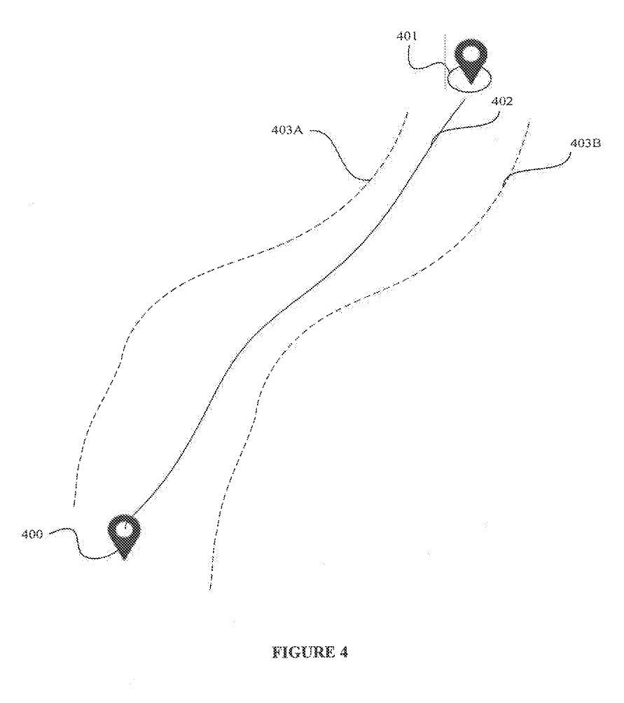

FIG. 2 illustrates internal architecture of the ECU 104 in accordance with some embodiments of the present disclosure. The ECU 104 may include at least one Central Processing Unit (“CPU” or “processor”) 203 and a memory 202 storing instructions executable by the at least one processor 203. The processor 203 may comprise at least one data processor for executing program components for executing user or system-generated requests. The memory 202 is communicatively coupled to the processor 203. The ECU 104 further comprises an Input/Output (I/O) interface 201. The I/O interface 201 is coupled with the processor 203 through which an input signal or/and an output signal is communicated.

In an embodiment, data 204 May be stored within the memory 2.02. The data 204 may include, for example, a reference path data 205, a threshold data 206 and other data 207.

In an embodiment, the reference path data 205 may include information about the reference path generated by the reference path generation unit 103. The reference path data 205 may include the source location, the destination location, length of the reference path, distance of left boundary and the right boundary from the reference path, and co-ordinates of various points involved in the formation of the reference path.

In an embodiment, the threshold data 206 may include information about the different thresholds used in the process of generating the safe navigation path. The threshold data 206 may include angular threshold for the vertical reference line and angular threshold for the horizontal reference line. The angular threshold for the vertical reference line indicates a range of angles to be considered for indicating inclination of each of the plurality of segments with the vertical reference line. The angular threshold for the horizontal reference line indicates a range of angles to be considered for indicating the inclination of each of the plurality of segments with the horizontal reference line.

In an embodiment, the other data 207 may comprise, but is not limited to, obstacle data, traffic information, terrain information, and the like. The obstacle data may indicate information on the obstacles present along the reference path. For example, the one or more obstacles in the reference path or the safe navigation path may be a wall or a divider. In another embodiment, the one or more obstacles may be a person or another vehicle.

In an embodiment, the data 204 in the memory 202 is processed by modules 208 of the ECU 104. As used herein, the term module refers to an application specific integrated circuit (ASIC), an electronic circuit, a field-programmable gate arrays (FPGA), Programmable System-on-Chip (PSoC), a combinational logic circuit, and/or other suitable components that provide the described functionality. The modules 208 when configured with the functionality defined in the present disclosure will result in a novel hardware.

In one implementation, the modules 208 may include, for example, a communication module 209, a perpendicular generator 210, a segment generator 211, an angle determination module 212, a line projection module 213, a centre point determination module 214, a safe path generation module 215 and other modules 216. It will be appreciated that such aforementioned modules 208 may be represented as a single module or a combination of different modules. Further, person of ordinary skill in the art will appreciate that in an implementation, the modules 208 may be integrated with the memory 202.

The communication module 209 facilitates communication between the ECU 104 and other units (not shown in figures) of the vehicle. In an embodiment, the other units may comprise, but are not limited to, the sensing unit 101, the vehicle localization unit 102, the reference path generation unit 103, and the navigation unit 105. For example, the communication module 209 may receive the reference path from reference path generation unit 103. In an embodiment, the communication module 209 may help in communication between the other units.

In an embodiment, the perpendicular generator 210 generates a line perpendicular to the orientation of the vehicle. The perpendicular generator 210 receives the reference path from the communication module 209. The reference path is confined between the left boundary and the right boundary. The perpendicular generator 210 generates the line perpendicular to the orientation of the vehicle present at the source location, to at least one of the left boundary and the right boundary. An end point of the line projected towards the left boundary lies on the left boundary and the end point of the line projected towards the right boundary lies on the right boundary.

In an embodiment, the segment generator 211 generates the plurality of segments along at least one of the left boundary and the right boundary. The first segment of the plurality of segments may be generated starting from the end point of the line. In an embodiment, the plurality of segments may be generated on either the left boundary or the right boundary. Each of the plurality of segments may be a straight line and may be generated with respect to the orientation of at least one of the left boundary and the right boundary. Each of the plurality of segments may have a pre-determined length. In an embodiment, the pre-determined length of each of the plurality of segments may be based on a type of the road. For an instance, consider a road with a straight profile. Each of the plurality of segments may be of a longer length. In another instance, for a road with a curved profile, each of the plurality of segments generated may be of a shorter length. In another embodiment, each of the plurality of segments may be generated at random length intervals.

In an embodiment, the angle determination module 212 determines an angle between each of the plurality of segments and at least one of the horizontal reference line and the vertical reference line. The angle between each of the plurality of segments and at least one of the horizontal reference line and the vertical reference line may be based on an angular threshold. In an embodiment, the horizontal reference line may be a line along the x axis or parallel to the x-axis (as defined by the cartesian co-ordinate system). In another embodiment, the vertical reference line may be a line along the y-axis or parallel to the y-axis (as defined by the cartesian co-ordinate system). A first angular region may be defined for the horizontal reference line and a second angular region may be defined for the vertical reference line. If the angle determined between a given segment and at least one of the horizontal reference line and vertical reference line falls in the first angular region, the given segment is considered to be inclined to the horizontal reference line. Similarly, if the angle determined between given segment and at least one of the horizontal reference line and vertical reference line falls in the second angular region, the given segment is considered to be inclined to the vertical reference line.

In an embodiment, the line projection module 213 projects at least one of a horizontal line and a vertical line from a predefined point of each of the plurality of segments to an opposite road boundary, based on the angle between each of the plurality of segments with at least one of a horizontal reference line and a vertical reference line. The predefined point may be a starting point of each of the plurality of segments. In an embodiment, the predefined point may be any point on a segment. Based on the determined angle between each of the plurality of segments and at least one of the horizontal reference line and a vertical reference line, the line projection module 213 projects either a horizontal line or a vertical line from the predefined point on each of the plurality of segments to the opposite road boundary. If the determined angle for the given segment falls in the first angular region i.e., the given segment is inclined towards the horizontal reference line, the vertical line is projected from the predefined point on the given segment to the opposite road boundary. Similarly, if the determined angle for the given segment falls in the second angular region i.e., the given segment is inclined towards the vertical reference line, the horizontal line is projected from the predefined point on the given segment to the opposite road boundary.

In an embodiment, the centre point determination module 214 determines a centre point of the horizontal line and vertical line projected from each of the plurality of segments. The centre point of the horizontal line and vertical line projected from each of the plurality of segments may be referred as centre points hereafter in the present disclosure.

In an embodiment, the safe path generation module 215, generates a safe path. The safe path may be generated by serially connecting the centre points determined by the centre point determination module 214. In an embodiment, the centre points may be curve fitted to generate the safe path along the centre of the road between the left boundary and the right boundary.

In an embodiment, the other modules 216 may include, but is not limited to, an indication module to indicate the safe path generated by the ECU 104, etc. The indication module may display the safe path generated to a user. The indication module may be one of, but not limited to a monitor, a Liquid Crystal Display (LCD), a Light Emitting Diode (LED) display and/or any other module present which is capable of displaying an output. In an embodiment the indication module may be present in a user device, wherein the user may utilize the safe path for navigation.

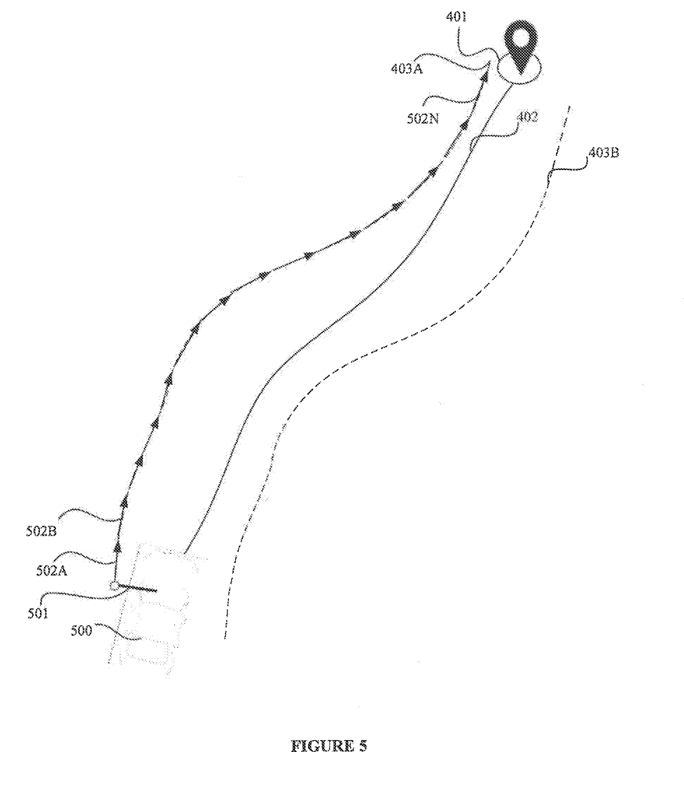

FIG. 3 illustrates exemplary method steps for generating a safe navigation path for a vehicle, in accordance with some embodiments of the present disclosure.

As illustrated in FIG. 3, the method 300 may comprise one or more steps for generating safe navigation path for the vehicle, in accordance with some embodiments of the present disclosure. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

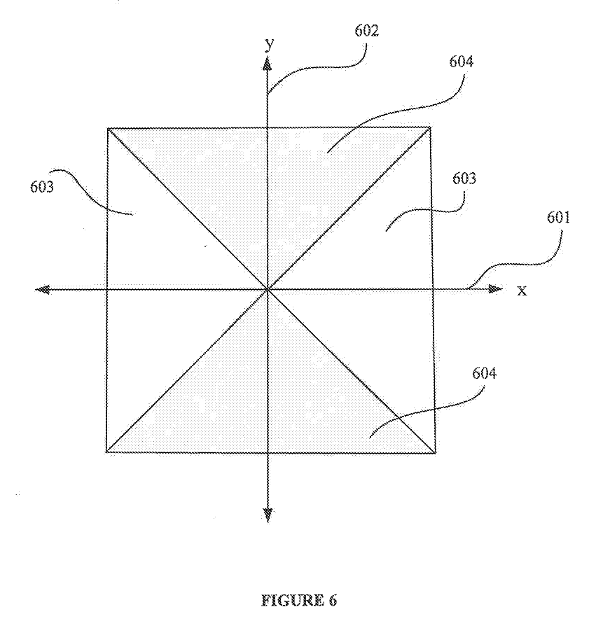

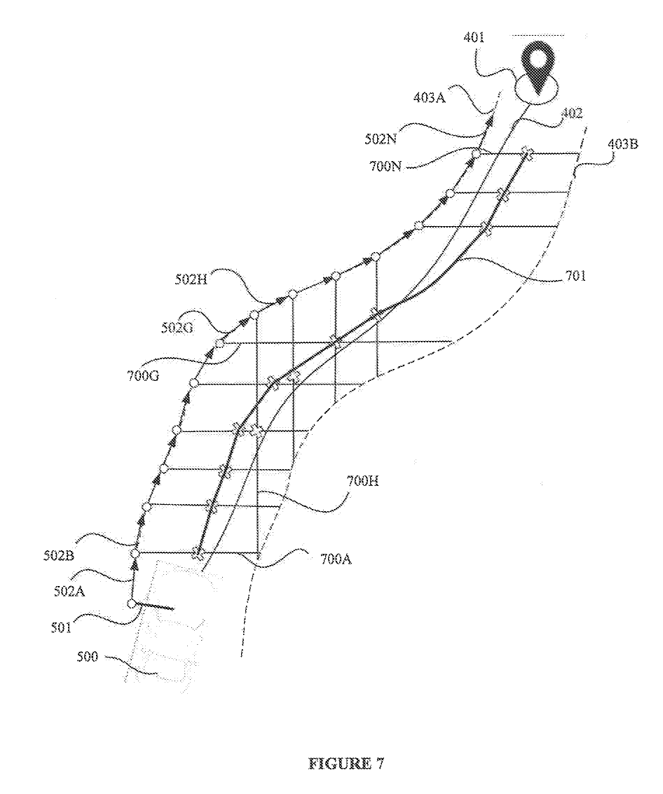

At step 301, the communication module 209 receives the reference path generated by the reference path generation unit 103. The reference path comprises the left boundary and the right boundary. The reference path received by the communication module 209 is illustrated using FIG. 4.

FIG. 4 illustrates the reference path received by the communication module 209. The illustrated FIG. 4 comprises a source 400, a destination 401, a reference path 402 generated from the source 400 to the destination 401, a left boundary 403A and a right boundary 403B. A road connects the source 400 to the destination 401. The left boundary 403A indicates the left edge of the road and the right boundary 403B indicates the right edge of the road. The reference path 402 generated along the road may be confined between the left boundary 403A and the right boundary 403B. The left boundary 403A and the right boundary 403B are illustrated using dotted lines in the FIG. 4. The reference path 402 may be a random path generated between the source 400 and the destination 401.

Referring back to FIG. 3, at step 302, the perpendicular generator 210 venerates the line perpendicular to the orientation of the vehicle. The perpendicular generator 210 receives the reference path from the communication module 209. The perpendicular generator 210 generates a line perpendicular to the orientation of the vehicle present at the source location, to at least one of the left boundary and the right boundary. An end point of the line projected towards the left boundary lies on the left boundary and the end point of the line projected towards the right boundary lies on the right boundary.

At step 303, the segment generator 211 generates the plurality of segments along at least one of the left boundary and the right boundary. The first segment of the plurality of segments may be generated starting from the end point of the line. In an embodiment, the plurality of segments may be generated on either the left boundary or the right boundary. Each of the plurality of segments may be a straight line and may be generated with respect to the orientation of at least one of the left boundary and the right boundary. Each of the plurality of segments may have a pre-determined length. In an embodiment, the pre-determined length of each of the plurality of segments may be based on the type of a road.

In an embodiment, the plurality of segments may be generated along either of the left boundary or the right boundary, starting from the end point of the line. The length of each of the plurality of segments may be pre-determined. In another embodiment, each of the plurality of segments may be generated at random length intervals. Generation of the perpendicular line and the plurality of segments are illustrated in FIG. 5.

FIG. 5 illustrates generation of the perpendicular line and the plurality of segments by the perpendicular generator 210 and the segment generator 211 respectively. The illustrated FIG. 5 comprises the source 400, the destination 401, the reference path 402, the left boundary 403A, the right boundary 403B, a vehicle 500, a perpendicular line 501, a first segment 502A, . . . , a nth segment 502N. The first segment 502A, . . . , the nth segment 502N may be collectively represented as plurality of segments 502. The vehicle 500 is present at the source 400 (not shown). The reference path 402 confined between the left boundary 403A and right boundary 403B as illustrated in FIG. 4 is received by the perpendicular generator 210. The perpendicular generator 210 generates a perpendicular line 501, perpendicular to the orientation of the vehicle 500 present at the source 400 to the left boundary 403A. In an embodiment the perpendicular generator 210 may generate a perpendicular line 501, perpendicular to the orientation of the vehicle 500 present at the source 400 to the right boundary 403B. Starting from the end point (illustrated as a circular point at the end of the perpendicular line 501) of the perpendicular line 501, the segment generator 211 generates the first segment 502A of pre-determined length. Generation of second segment 502B may be initiated from an end point where the first segment 502A terminates. Similarly, the segments 502B, . . . , 502N of the pre-determined length are generated by the segment generator 211. The segments 502B . . . 502N are generated along the left boundary 403A based on the orientation of the left boundary 403A as illustrated in FIG. 5.

Referring back to FIG. 3, at step 304, the angle determination module 212 determines the angle between each of the plurality of segments and at least one of the horizontal reference line and vertical reference line. The angle between each of the plurality of segments and at least one of the horizontal reference line and vertical reference line may be compared with the angular threshold. In an embodiment, the horizontal reference line may be a line along the x axis or parallel to the x-axis (as defined by the cartesian co-ordinate system). In another embodiment, the vertical reference line may be a line along the y-axis or parallel to the y-axis (as defined by the cartesian co-ordinate system). Upon determining the angle between each of the plurality of segments and at least one of the horizontal reference line and vertical reference line, the angle determination module 212 determines an inclination of each of the plurality of segments with at least one of the horizontal reference line and vertical reference line based on comparison of the angle with a first angular region and a second angular region. The first angular region may be a predefined area about the horizontal reference line and the second angular region may be a predefined area about the vertical reference line. If the angle determined between a given segment and at least one of the horizontal reference line and vertical reference line falls within the first angular region, the given segment is considered to be inclined to the horizontal reference line. Similarly, if the angle determined between given segment and at least one of the horizontal reference line and vertical reference line falls within the second angular region, the given segment is considered to be inclined to the vertical reference line.

In an embodiment, when the angle determined between given segment and at least one of the horizontal reference line and vertical reference line falls exactly on a line demarcating the first angular region and second angular region, the inclination of the given segment is chosen at random or may be based on the previously generated segment. The first and second angular region is illustrated using FIG. 6.

FIG. 6 illustrates angular regions considered by the angle determination module 212, for determining the inclination of each of the plurality of segments with at least one of the horizontal reference line and the vertical reference line. The illustrated FIG. 6 comprises a horizontal reference line 601, a vertical reference line 602, four quadrants formed by the intersection of the horizontal reference line and the vertical reference line, a first angular region 603, and a second angular region 604. The first angular region 603 is present about the horizontal reference line 601. The second angular region 604 is present about the vertical reference line 602. The first angular region 603 and the second angular region 604 define a range of angles that lie within the first angular region 603 and the second angular region 604 respectively. For an instance the second angular region 604 may be defined between 45°-135° and 225°-315°. If the angle determined for the given segment lies within the range defined above, the given segment is considered to have an alignment with the vertical reference line.

Referring back to FIG. 3, at step 305, the line projection module 213 projects least one of the horizontal line and the vertical line from the predefined point of each of the plurality of segments to the opposite road boundary, based on the angle between each of the plurality of segments with at least one of a horizontal reference line and a vertical reference line. The predefined point may be a starting point of each of the plurality of segments. In an embodiment, the predefined point may be any defined point on each of the plurality of segments. If the determined angle for the given segment falls in the first angular region i.e., the given segment is inclined towards the horizontal reference line, the vertical line is projected from the predefined point on the given segment to the opposite road boundary. Similarly, if the determined angle for the given segment falls in the second angular region i.e., the given segment is inclined towards the vertical reference line, the horizontal line is projected from the predefined point on the given segment to the opposite road boundary. Projection of the horizontal line and vertical line is illustrated using FIG. 7.

FIG. 7 illustrates projection of the horizontal line and vertical line from the predefined point on each of the plurality of segments to the opposite road boundary. The illustrated FIG. 7 comprises the source 400 (not shown), the destination 401, the reference path 402, the left boundary 403A, the right boundary 403B, the vehicle 500, the perpendicular line 501, the plurality of segments 502 generated along the left boundary 403A, a horizontal/vertical line 700A . . . , a horizontal/vertical line 700N and a safe navigation path 701. The vehicle 500 is present at the source 400. The horizontal/vertical line 700A . . . , the horizontal/vertical line 700N may be collectively represented as one or more horizontal/vertical line 700 hereafter in the present disclosure. Upon determination of the angle of each of the one or more segments with at least one of the horizontal reference line and the vertical reference line, the line projection module 213 projects one of the horizontal line and vertical line from the predefined point on each of the plurality of segments to the opposite road boundary. As illustrated in FIG. 7, consider the second segment 502B. Let the angle between the second segment 502B and the vertical reference line lie within the second angular region. Thus, the second segment is inclined towards the vertical reference line. The line projection module 213 projects the horizontal line 700A from the starting point of the second segment 502B to the right boundary 403B. Considering the segment 502G, the angle determined between the segment 502B and at least one of the horizontal reference line and vertical reference line falls exactly on a line demarcating the first angular region and second angular region. Thereby, a horizontal segment 700G is generated at random. Considering the segment 502H, the angle determined between the segment 502H and at least one of the horizontal reference line and vertical reference line falls in the first angular region. The segment 502H is therefore inclined to the horizontal reference line. Thereby, the line projection module 213 projects the vertical line 700H from, the starting point of the segment 502H to the right boundary 403B. Similar procedure is repeated for each of the plurality of segments 502.

Referring back to FIG. 3, at step 306, the centre point determination module 214 determines the centre point of the horizontal line and vertical line projected from each of the plurality of segments.

At step 307, the safe path generation module 215, generates the safe path. The safe path may be generated by serially connecting the centre points determined by the centre point determination module 214. In an embodiment, the centre points may be curve fitted to generate the safe path along the centre of the road between the left boundary and the right boundary. Safe navigation path generation is illustrated in FIG. 7.

Referring back to FIG. 7, a centre point is determined for one or more horizontal/vertical line 700 projected from each of the plurality of segments 502. Further, the centre point determined for one or more horizontal/vertical line 700 is illustrated by a cross mark (X) in the FIG. 7. The safe navigation path 701 may be generated by curve fitting the centre point determined for one or more horizontal/vertical line 700.

### Computer System

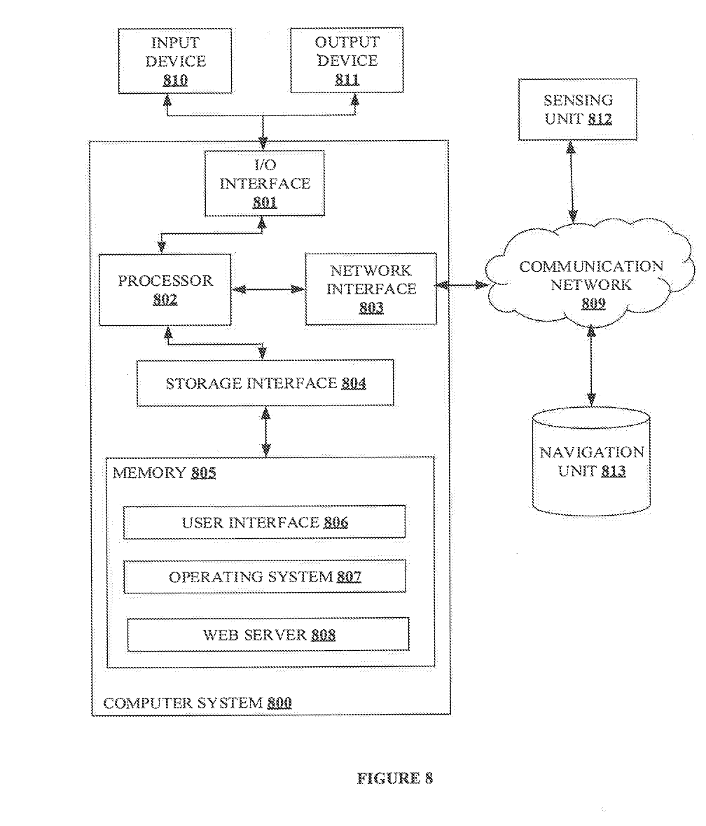

FIG. 8 illustrates a block diagram of an exemplary computer system 800 for implementing embodiments consistent with the present disclosure. In an embodiment, the computer system 800 is used to implement the navigation path generation system 100. The computer system 800 may comprise a central processing unit (“CPU” or “processor”) 802. The processor 802 may comprise at least one data processor for generating a safe navigation path for a vehicle. The processor 802 may include specialized processing units such as integrated system (bus) controllers, memory management control units, floating point units, graphics processing units, digital signal processing units, etc.

The processor 802 may be disposed in communication with one or more input/output (I/O) devices (not shown) via I/O interface 801. The I/O interface 801 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (e.g., code-division multiple access (CDMA), high-speed packet access (HSRA+), global system for mobile communications (GSM), long-term evolution (LTE), WiMax, or the like), etc.

Using the I/O interface 801, the computer system 800 may communicate with one or more I/O devices. For example, the input device 810 may be an antenna, keyboard, mouse, joystick, (infrared) remote control, camera, card reader, fax machine, dangle, biometric reader, microphone, touch screen, touchpad, trackball, stylus, scanner, storage device, transceiver, video device/source, etc. The output device 811 may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the computer system 800 consists of a navigation path generation system 100. The processor 802 may be disposed in communication with the communication network 809 via a network interface 803. The network interface 803 may communicate with the communication network 809. The network interface 803 may employ connection protocols including, without limitation, direct connect, Ethernet (e.g., twisted pair 10/100/1000 Base T), transmission control protocol/Internet protocol (TCP/IP), token ring, IEEE 802.11a/b/g/n/x, etc. The communication network 809 may include, without limitation, a direct interconnection, local area network (LAN), wide area network (WAN), wireless network (e.g., using Wireless Application Protocol), the Internet, etc. Using the network interface 803 and the communication network 809, the computer system 800 may communicate with a sensing unit 812 and a navigation unit 813. The network interface 803 may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network 809 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 802 may be disposed in communication with a memory 805 (e.g., RAM, ROM, etc. not shown in FIG. 8) via a storage interface 804. The storage interface 804 may connect to memory 805 including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 805 may store a collection of program or database components, including, without limitation, user interface 806, an operating system 807, web server 808 etc. In some embodiments, computer system 800 may store user/application data 806, such as, the data, variables, records, etc., as described in this disclosure. Such databases may be implemented as fault-tolerant, relational, scalable, secure databases such as Oracle® or Sybase®.

The operating system 807 may facilitate resource management and operation of the computer system 800. Examples of operating systems include, without limitation, APPLE MACINTOSH® OS X, UNIX®, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™ UBUNTU™, KUBUNTU™, etc.), IBM™OS/2, MICROSOFT™ WINDOWS™ (XP™, VISTA™/7/8, 10 etc.), APPLE® IOS™, GOOGLE® ANDROID™, BLACKBERRY® OS, or the like.

In some embodiments, the computer system 800may implement a web browser 808stored program component. The web browser 808may be a hypertext viewing application, for example MICROSOFT® INTERNET EXPLORER™, GOOGLE® CHROME™. MOZILLA® FIREFOX™, APPLE® SAFARI™, etc. Secure web browsing may be provided using Secure Hypertext Transport Protocol (HTTPS), Secure Sockets Layer (SSL), Transport Layer Security (TLS), etc. Web browsers 808may utilize facilities such as AJAX™, DHTML™, ADOBE® FLASH™, JAVASCRIPT™, JAVA™, Application Programming Interfaces (APIs), etc. In some embodiments, the computer system 800may implement a mail server stored program component. The mail server may be an Internet mail server such as Microsoft Exchange, or the like. The mail server may utilize facilities such as ASP™, ACTIVEX™, ANSI™ C++/C#, MICROSOFT®, .NET™, CGI SCRIPTS™, JAVA™, JAVASCRIPT™, PERL™, PHP™, PYTHON™, WEBOBJECTS™, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the computer system 800may implement a mail client stored program component. The mail client may be a mail viewing application, such as APPLE® MAIL™, MICROSOFT® ENTOURAGE™, MICROSOFT® OUTLOOK™, MOZILLA® THUNDERBIRD™, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, CD ROMs, DVDs, flash drives, disks, and any other known physical storage media.

In an embodiment, the method steps 300 may be performed in real-time.

In an embodiment, the present disclosure discloses a method for generating a safe path for a vehicle along the centre of the road. Navigation of the vehicle along the safe path ensures the safety of the vehicle and the people in the vehicle especially when the vehicle is an autonomous or semi-autonomous vehicle.

In an embodiment, the present disclosure discloses a method and system for generating a safe navigation path along the centre of the road.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise. The terms “a”, “an” and the mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 3 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following

### REFERRAL NUMERALS

| Reference | |
|---|---|
| number | Description |
| 100 | Navigation path generation system |
| 101 | Sensing unit |
| 102 | Vehicle localization unit |
| 103 | Reference path generation unit |
| 104 | Electronic Control unit |
| 105 | Navigation unit |
| 201 | I/O Interface |
| 202 | Memory |
| 203 | Processor |
| 204 | Data |
| 205 | Reference path data |
| 206 | Threshold data |
| 207 | Other data |
| 208 | Modules |
| 209 | Communication module |
| 210 | Perpendicular generator |
| 211 | Segment generator |
| 212 | Angle determination module |
| 213 | Line projection module |
| 214 | Centre point determination module |
| 215 | Safe path generation module |
| 216 | Other modules |
| 400 | Source |
| 401 | Destination |
| 402 | Reference path |
| 403A | Left boundary |
| 403B | Right boundary |
| 500 | vehicle |
| 501 | Perpendicular line |
| 502 | Plurality of segments |
| 700 | One or more horizontal/vertical line |
| 701 | Safe navigation path |
| 800 | Computer System |
| 801 | I/O Interface of the exemplary Computer system |
| 802 | Processor of the exemplary Computer system |
| 803 | Network Interface |
| 804 | Storage Interface |
| 805 | Memory of the exemplary Computer system |
| 806 | User Interface of the exemplary Computer system |
| 807 | Operating System |
| 808 | Web Server |
| 809 | Communication Network |
| 810a, . . . , 810n | Input Devices |
| 811a, . . . , 811n | Output device |
| 812 | Sensing unit of the exemplary Computer system |
| 813 | Navigation unit of the exemplary Computer system |

We claim:

1. A method for generating safe navigation path for a vehicle, the method comprising:
receiving, by a navigation path generation system, a reference path between a source and a destination, wherein the reference path is confined between a left boundary and a right boundary;
projecting, by a navigation path generation system, a line perpendicular to an orientation of the vehicle present at the source, to at least one of the left boundary and the right boundary, wherein an end point of the line projected towards the left boundary lies on the left boundary and wherein the end point of the line projected towards the right boundary lies on the right boundary;
generating, by the navigation path generation system, a plurality of segments along at least one of the left boundary and the right boundary, starting from the end point of the line;
determining, by the navigation path generation system, an angle between each of the plurality of segments with at least one of a horizontal reference line and a vertical reference line;
projecting, by the navigation path generation system, at least one of a horizontal line and a vertical line from a predefined point of each of the plurality of segments to an opposite road boundary, based on the angle between each of the plurality of segments with at least one of a horizontal reference line and a vertical reference line;
determining, by the navigation path generation system, a centre point of the horizontal line and vertical line projected from each of the plurality of segments; and
generating, by the navigation path generation system, a safe navigation path for the vehicle based on the centre point of the horizontal line and vertical line projected from each of the plurality of segments.

2. The method as claimed in claim 1, wherein the reference path is received from a static map generated using a Light Detection and Ranging (LIDAR) system.

3. The method as claimed in claim 1, wherein each of the plurality of segments is a straight line generated with respect to the orientation of at least one of the left boundary and the right boundary, wherein each of the plurality of segments has a pre-determined length.

4. The method as claimed in claim 1, wherein the predefined point of each of the plurality of segments is a starting point of each of the plurality of segments.

5. The method as claimed in claim 1, wherein the angle between each of the plurality of segments with at least one of a horizontal reference line and a vertical reference line is compared with an angular threshold.

6. The method as claimed in claim 1, wherein the safe navigation path is generated based on a curve fitting of the centre point of the horizontal line and vertical line projected from each of the plurality of segments.

7. A navigation path generation system for generating a safe navigation path for a vehicle, the navigation path generation system comprising;
an Electronic Control Unit (ECU), configured to:
receive, a reference path between a source and a destination, wherein the reference path is confined between a left boundary and a right boundary;
project, a line perpendicular to an orientation of the vehicle present at the source, to at least one of the left boundary and the right boundary, wherein an end point of the line projected towards the left boundary lies on the left boundary and wherein the end point of the line projected towards the right boundary lies on the right boundary;
generate, a plurality of segments along at least one of the let boundary and the right boundary, starting from the end point of the line;
determine, an angle between each of the plurality of segments with at least one of a horizontal reference line and a vertical reference line;
project, at least one of a horizontal line and a vertical line from a predefined point of each of the plurality of segments to an opposite road boundary, based on the angle between each of the plurality of segments with at least one of a horizontal reference line and a vertical reference line;
determine, a centre point of the horizontal line and vertical line projected from each of the plurality of segments; and
generate, a safe navigation path for the vehicle based on the centre point of the horizontal line and vertical line projected from each of the plurality of segments.

8. The navigation path generation system as claimed in claim 7, wherein the reference path is received from a static map generated using a Light Detection and Ranging (LIDAR) system.

9. The navigation path generation system as claimed in claim 7, wherein each of the plurality of segments is a straight line generated with respect to the orientation of at least one of the left boundary and the right boundary, wherein each of the plurality of segments has a pre-determined length.

10. The navigation path generation system as claimed in claim 7, wherein the predefined point of each of the plurality of segments is a starting point of each of the plurality of segments.

11. The navigation path generation system as claimed in claim 7, the angle between each of the plurality of segments with at least one of a horizontal reference line and a vertical reference line is compared with an angular threshold.

12. The navigation path generation system as claimed in claim 7, wherein the safe navigation path is generated based on a curve fitting of the centre point of the horizontal line and vertical line projected from each of the plurality of segments.

13. A non-transitory computer readable medium including instruction stored thereon that when processed by at least one processor cause a navigation path generation system to perform operation comprising:
receiving a reference path between a source and a destination, wherein the reference path is confined between a left boundary and a right boundary;
projecting a line perpendicular to an orientation of the vehicle present at the source, to at least one of the left boundary and the right boundary, wherein an end point of the line projected towards the left boundary lies on the left boundary and wherein the end point of the line projected towards the right boundary lies on the right boundary;
generating a plurality of segments along at least one of the left boundary and the right boundary, starting from the end point of the line;
determining an angle between each of the plurality of segments with at least one of a horizontal reference line and a vertical reference line;
projecting at least one of a horizontal line and a vertical line from a predefined point of each of the plurality of segments to an opposite road boundary, based on the angle between each of the plurality of segments with at least one of a horizontal reference line and a vertical reference line;
determining a centre point of the horizontal line and vertical line projected from each of the plurality of segments; and
generating a safe navigation path for the vehicle based on the centre point of the horizontal line and vertical line projected from each of the plurality of segments.

14. The medium as claimed in claim 13, wherein the reference path is received from a static map generated using a Light Detection and Ranging (LIDAR) system.

15. The medium as claimed in claim 13, wherein each of the plurality of segments is a straight line generated with respect to the orientation of at least one of the left boundary and the right boundary, wherein each of the plurality of segments has a pre-determined length.

16. The medium as claimed in claim 13, wherein the predefined point of each of the plurality of segments is a starting point of each of the plurality of segments.

17. The medium as claimed in claim 13, wherein the angle between each of the plurality of segments with at least one of a horizontal reference line and a vertical reference line is compared with an angular threshold.

18. The medium as claimed in claim 13, wherein the safe navigation path is generated based on a curve fitting of the centre point of the horizontal line and vertical line projected from each of the plurality of segments.
